(19) United States
(12) Patent Application Publication
(10) Pub. No.: US 2013/0062415 A1
(43) Pub. Date: Mar. 14, 2013

(54) System and Method for Protecting a Machine Readable Card

(71) Applicants: Kristopher Barnings, Amarillo, TX (US); Walter Steelman, Amarillo, TX (US)

(72) Inventors: Kristopher Barnings, Amarillo, TX (US); Walter Steelman, Amarillo, TX (US)

(21) Appl. No.: 13/229,732

(22) Filed: Sep. 11, 2011

(51) Int. Cl. G06K 19/02; B65B 1/04

(52) U.S. Cl. 235/488; 53/473

(57) ABSTRACT

A system for protecting a machine readable card is disclosed. Said system comprising a cover and a machine readable card. Said cover having a first side, a second side, a cover height, a cover width, and a cover thickness. Said machine readable card comprising one or more machine readable components, a card width and a card height. Said cover is capable of attaching and covering a portion of said machine readable card. Said cover is capable of detaching from and reapplying to a portion of said machine readable card.

### BACKGROUND

This disclosure relates generally to a system and method for protecting a machine readable card. In one embodiment, said machine readable card comprises a credit card, but use of a credit card is illustrative only and not limiting.

Machine readable cards (such as a credit card, a government identification card, a driver's license, a corporate identification card, a student identification card, or similar) are a well-known part of modern life. Many people are bound to carry around many of said machine readable cards for extended periods of every day. Their ubiquity has arisen on account of their convenience and many uses. Despite their usefulness, however, many components of said machine readable cards are fragile and prone to damage. For example, some cards comprise a magnetic strip. Magnetic strips are prone to damage due to repeated use due to friction wearing away critical portions of said magnetic strip. Likewise, holograms, electronic tags, thumbprints, and signatures are prone to harm due to repeated use and movement of said machine readable cards. Such use and movement can occur by the act of reading a magnetic strip with a card reader (sometimes called “swiping” a card). In another embodiment, merely carrying a card in one's pocket can cause a frequent rubbing of one card on another and thereby ruining a portion of said card. Likewise, carrying multiple cards in a stack in a pocket can cause several cards to be harmed due to said frequent rubbing.

Solutions for protecting said machine readable cards are well-known but, ultimately, ineffective. For example, in one embodiment, banks will ship new cards to users in a card sized envelope. Some such envelopes comprise protective materials for keeping their contents safe from friction and other harmful elements. This approach, however, only works where a user is willing to keep track of the bank issued envelope. This goal often proves to be unachievable due to mishandling and misplacing said envelope. Further, where said card is held in said envelope, the combination of the two is unlikely to fit in a standard credit card slot in an envelope. Consequently, many banks have ceased to issue cards in said envelopes altogether.

Another approach is to laminate said machine readable cards to ensure that portions of said cards are protected from harm. This approach fails, however, because lamination often makes cards unreadable by card readers. For example, in one embodiment, a laminated credit card will be too thick for a credit card reader. In another embodiment, a magnetic strip cannot be read through said lamination. Further, lamination is not removable and repositionable in cases where the machine readable card must be replaced or altered.

None of the above inventions, taken either singularly or in combination, is seen to describe the instant disclosure as claimed. Accordingly, an improved system and method for protecting a machine readable card would be advantageous.

### SUMMARY

Two systems and one method for protecting a card are disclosed. First, a system for protecting a machine readable card is disclosed. Said system comprising a cover and a machine readable card. Said cover having a first side, a second side, a cover height, a cover width, and a cover thickness. Said machine readable card comprising one or more machine readable components, a card width and a card height. Said cover is capable of attaching and covering a portion of said machine readable card. Said cover is capable of detaching from and reapplying to a portion of said machine readable card. Next, a method for protecting a card is disclosed. Said method comprising: aligning a cover with a portion of a card and applying said cover to a second side of said card. Said cover comprises a first side, said second side, a cover height, a cover width, and a cover thickness. Said card comprises a card width, a card height, a first side, a second side, and a card thickness. Said cover is capable of detaching from and reapplying to said card. Finally, a system for protecting an identification card is disclosed. Said system comprising: a cover and an identification card. Said cover having a first side, a second side, a cover height, a cover width, and a cover thickness. Said identification card comprising one or more identification components, a card width and a card height. Said cover is capable of attaching and covering a portion of said identification card. Said cover is capable of detaching from said and reapplying to said identification card.

### BRIEF DESCRIPTION OF THE DRAWINGS

FIGS. 1A and 1B illustrate a front view and a back view of a card.

FIGS. 2A, 2B, 2C and 2D illustrate an unapplied view, an application view, a top applied view, and a side applied view of a cover being applied to card.

FIGS. 3A, 3B, 3C and 3D illustrate an unapplied view, an application view, a top applied view, and a side applied view of a cover being applied to magnetic strip on card.

FIG. 4 illustrates a bottom view of card with cover, and cover comprises one or more graphics.

### DETAILED DESCRIPTION

Described herein is a system and method for protecting a machine readable card. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

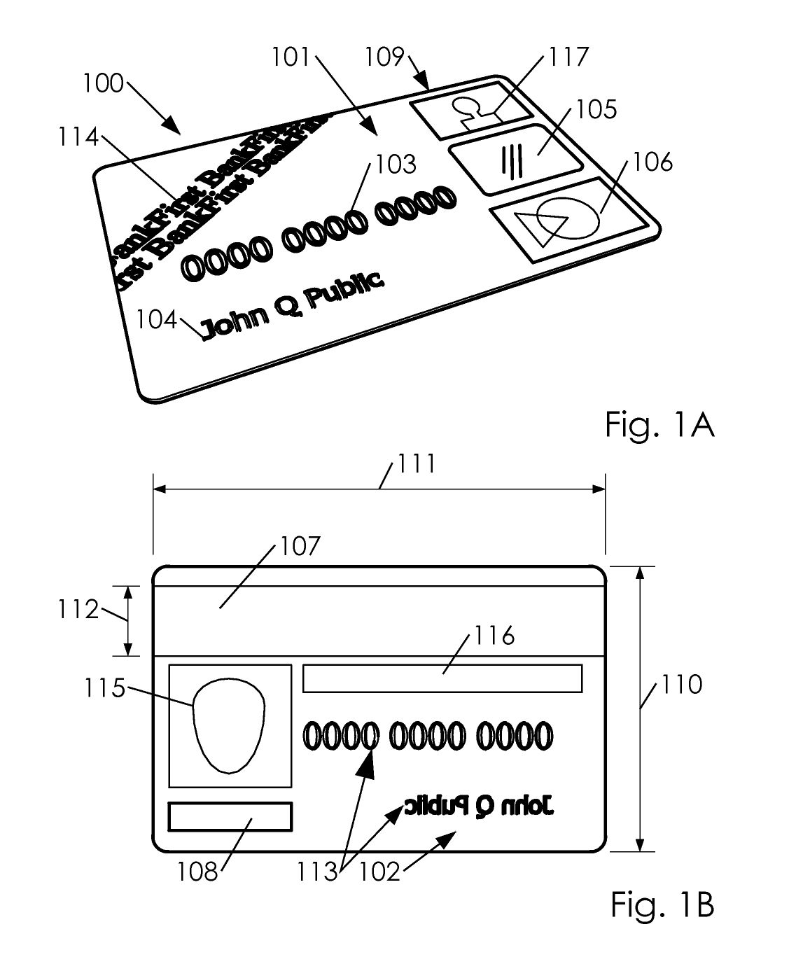

FIGS. 1A and 1B illustrate a front view and a back view of a card 100. Card 100 can comprise a first side 101, a second side 102, an identifier 103, a username 104, hologram 105, a bank logo 106, a magnetic strip 107, and an electronic tag 108. Further, card 100 can comprise a card height 110 and a card width 111. In one embodiment, magnetic strip 107 can comprise a magnetic strip height 112. In one embodiment, identifier 103 and username 104 can be stamped into card 100 thereby creating one or more indentions 113 in second side 102. Further, card 100 can comprise a watermark 114, a thumbprint 115 a signature block 116 and a user picture 117. In one embodiment, card 100 can comprise one or more machine readable components, such as identifier 103, username 104, magnetic strip 107, electronic tag 108, watermark 114, thumbprint 115 or signature block 116. In one embodiment, card 100 can comprise identifying components such as identifier 103, username 104, hologram 105, bank logo 106, magnetic strip 107, electronic tag 108, watermark 114, thumbprint 115, signature block 116, or user picture 117. Said card 100 can comprise identifying information, protected information, privileged information, or similar. In one embodiment, portions of card 100 can be capable of reflecting an otherwise hidden message when an irregular light is shown thereupon; for example, in one embodiment, hologram 105 or watermark 114 can comprise an image visible only when a black light is reflected off of it. In one embodiment, card 100 can comprise a credit card, a government identification card, a driver's license, a corporate identification card, a student identification card, or similar. In one embodiment, electronic tag can comprise an RFI strip, RFID tag, a short range wireless communications tag, a long range wireless communications tag, or a wireless communications tag.

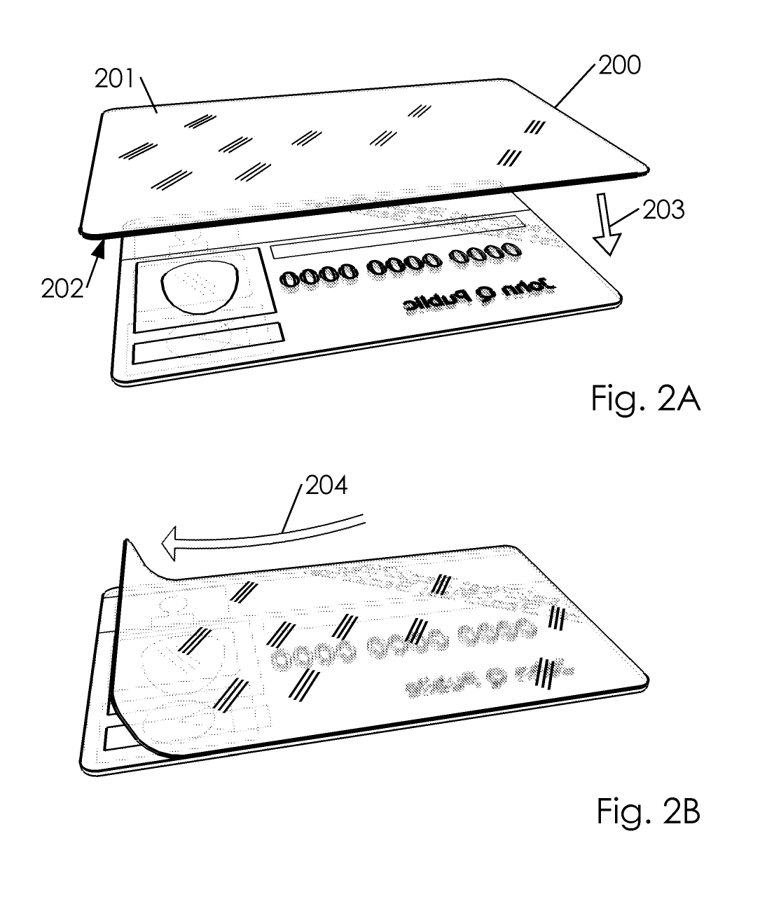

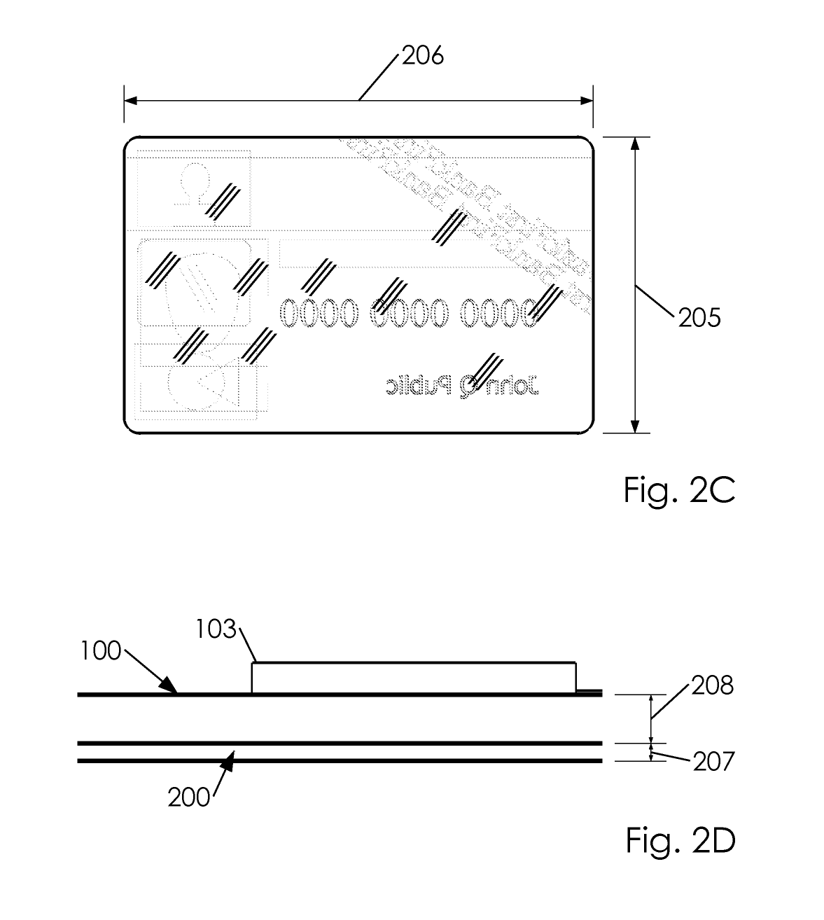

FIGS. 2A, 2B, 2C and 2D illustrate an unapplied view, an application view, a top applied view, and a side applied view of a cover 200 being applied to card 100. In one embodiment, cover 200 can be used for protecting card 100. Cover 200 can comprise a first side 201 and a second side 202. In one embodiment, protecting card 100 with cover 200 can comprise: aligning cover 200 with card 100, pressing 203 said cover 200 onto card 100, and flattening 204 said cover 200 against card 100. Cover 200 can comprise a cover height 205, a cover width 206 and a cover thickness 207. Card 100 can comprise a card thickness 208. In one embodiment, cover width 206 can be equal to or less than card width 111. In one embodiment, cover height 205 can be equal to or less than card height 110. In one embodiment, cover 200 can completely cover second side 102 of card 100, as illustrated in FIGS. 2C and 2D.

In one embodiment, cover thickness 207 can be thin enough to ensure said machine readable components remain readable by a machine. Further, cover thickness 207 must be thin enough such that cover thickness 207 plus card thickness 208 are less than a threshold for said machines reading said machine readable components. For example, in one embodiment, cover thickness 207 can be 0.080mm or less. In one embodiment, one or more signals from card 100 can be read through cover 200. For example, in one embodiment, a signal from magnetic strip 107 can be read through cover 200. Likewise, a signal from electronic tag 108, hologram 105, watermark 114, identifier 103, username 104 or similar can be read through cover 200.

In one embodiment, cover 200 can be cut with a cutting device. In one embodiment, said cutting device can press a preset cutline into an uncut sheet of cover 200. In another embodiment, said cutting device can comprise a laser for cutting. In one embodiment, said cutting device can comprise a kiss cutting device. In yet another embodiment, said cutting device can use a die cut for cutting cover 200. In one embodiment, cover 200 can comprise a flexible material. In one embodiment, cover 200 can comprise a translucent material capable of visually exposing a portion of said second side of said machine readable card. In one embodiment, cover 200 can comprise a polyester film.

In one embodiment, cover 200 can comprise an adhesive on second side 202 capable of attaching said cover 200 to card 100. In one embodiment, said adhesive can comprise an acrylate polymer adhesive. In one embodiment, said adhesive can have a pH lacking acidity. In one embodiment, low acidity can protect card 100 by not removing a portion of card 100 (such as magnetic strip 107) when removing cover 200. In one embodiment, cover 200 can attach to card 100 with static electricity.

In one embodiment, cover 200 can be capable of attaching and covering a portion of said card 100. In one embodiment, cover 200 can be capable of detaching from and reapplying to card 100. In one embodiment, cover 200 can be repositionable on card 100 by pealing cover 200 from card 100, repositioning cover 200 on card 100, and reapplying cover 200 to card 100. Likewise, in one embodiment, cover 200 can be reused among a plurality of said cards 100.

In one embodiment, a method for protecting card 100 can comprise aligning cover 200 with a portion of card 100 and applying cover 200 to second side 102. In one embodiment, protecting card 100 can comprise applying a thumbprint 115 to card 100 and covering thumbprint 115 with cover 200. In one embodiment, thumbprint 115 can be protected from smearing and damage with cover 200. Likewise, protecting card 100 can comprise signing cover 200 in signature block 116 and covering signature block 116 with cover 200. In one embodiment, signature block 116 can be protected from smearing and damage with 200.

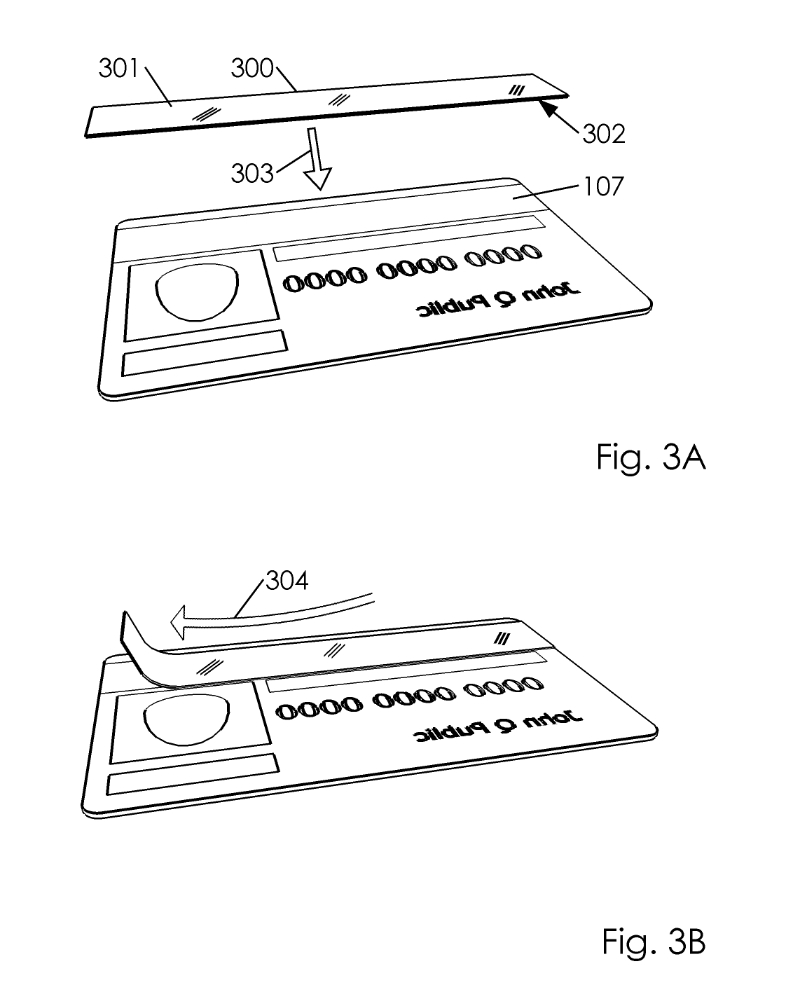

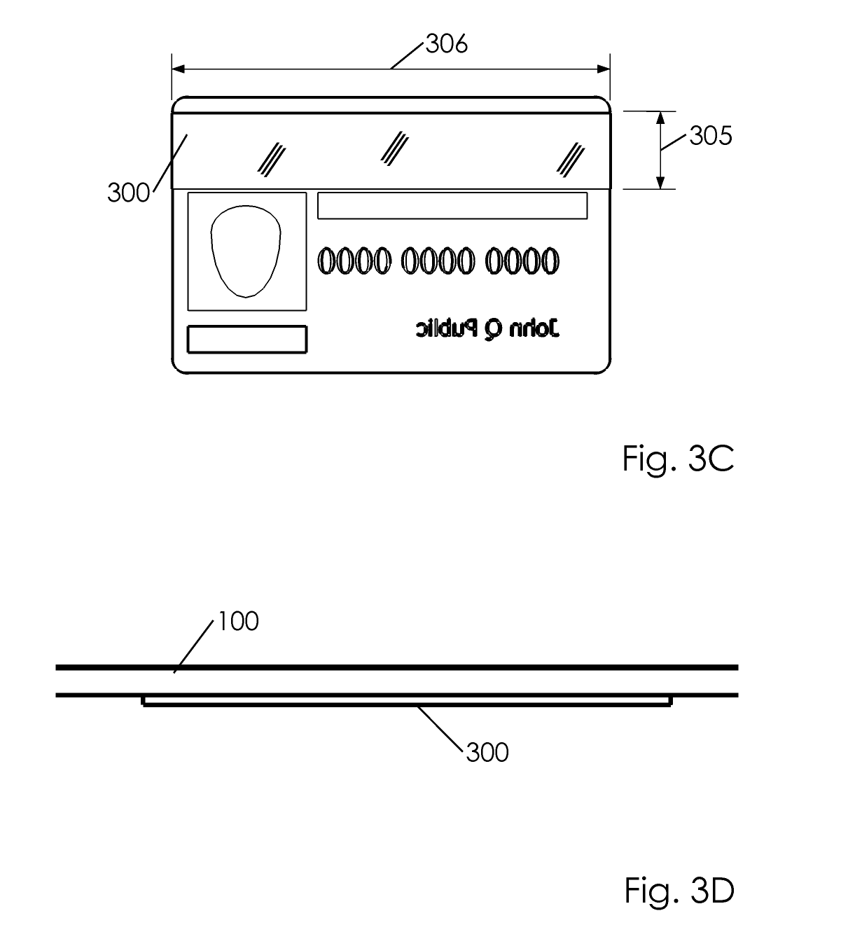

FIGS. 3A, 3B, 3C and 3D illustrate an unapplied view, an application view, a top applied view, and a side applied view of a cover 200 being applied to magnetic strip 107 on card 100. In one embodiment, cover 200 can cover a portion of card 100 smaller than second side 102. In one embodiment, cover 200 can comprise cover 300. In one embodiment, cover 300 can be used to protect magnetic strip 107 only. Cover 300 can comprise first side 301 and second side 302. In one embodiment, protecting magnetic strip 107 with cover 300 can comprise aligning cover 300 with magnetic strip 107 and applying cover 300 to magnetic strip 107. In one embodiment, applying cover 300 to magnetic strip 107 can comprise the steps of a pressing 303 and a flattening 304. In one embodiment, cover 300 can comprise a cover height 305 and a cover width 306. In one embodiment, cover height 305 is equal to or greater than magnetic strip height 112.

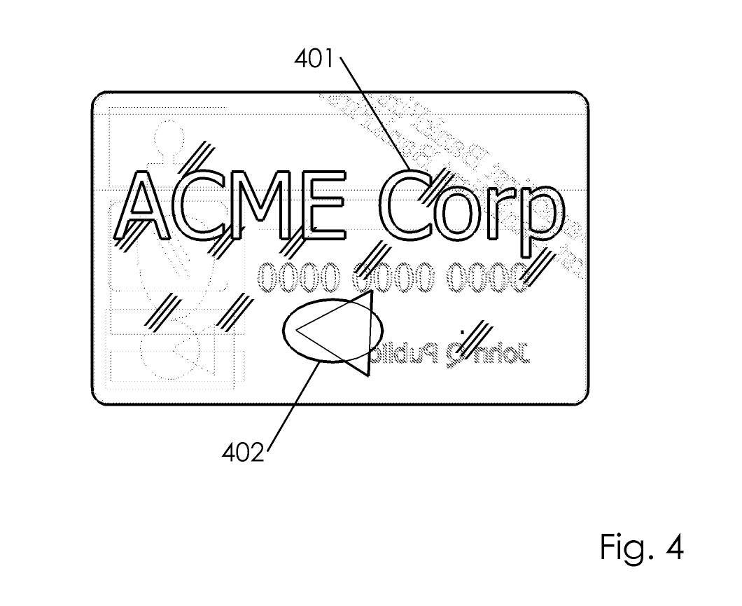

FIG. 4 illustrates a bottom view of card 100 with cover 200, and cover 200 comprises one or more graphics 400. Graphics 400 can comprise one or more text graphic 401 and/or one or more logo graphic 402. In one embodiment, graphics 400 can be used to decorate card 100. In one embodiment, graphics 400 can be used as an ornamental sales point for cover 200. In one embodiment, graphics 400 can comprise logos and slogans for a company. In one embodiment, graphics 400 can comprise important security information. In one embodiment, graphics 400 can comprise a disguise for card 100. In one embodiment, cover 200 can comprise a printable material capable of receiving one or more of said graphics 400. In one embodiment, said printable material comprises a thermal transfer printable material and/or a matte top-coat to receive said graphics.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for protecting a machine readable card comprising:
a cover having a first side, a second side, a cover height, a cover width, and a cover thickness; and,
a machine readable card comprising one or more machine readable components, a card width and a card height; wherein,
said cover is capable of attaching and covering a portion of said machine readable card, and
said cover is capable of detaching from and reapplying to a portion of said machine readable card.

2. The system for protecting a machine readable card claim 1 wherein said one or more machine readable components comprise a magnetic strip having a magnetic strip height and a magnetic strip width.

3. The system for protecting a machine readable card of claim 2 wherein said cover protects said magnetic strip by
aligning said cover with said magnetic strip and
applying said cover to said machine readable card so as to entirely cover said magnetic strip; further wherein,
said cover height is greater than said magnetic strip height.

4. The system for protecting a machine readable card claim 1 wherein said one or more machine readable components comprise an electronic tag.

5. The system for protecting a machine readable card of claim 4 wherein said electronic tag comprises an RFI strip.

6. The system for protecting a machine readable card of claim 4 wherein said electronic tag comprises a wireless communications tag.

7. The system for protecting a machine readable card of claim 1 wherein said cover comprises a flexible material.

8. The system for protecting a machine readable card of claim 1 wherein said cover comprises a translucent material capable of visually exposing a portion of said second side of said machine readable card.

9. The system for protecting a machine readable card of claim 1 wherein said cover comprises a polyester film.

10. The system for protecting a machine readable card of claim 1 wherein said cover comprises a printable material capable of receiving one or more graphics.

11. The system for protecting a machine readable card of claim 10 wherein said graphics comprises a text graphic.

12. The system for protecting a machine readable card of claim 10 wherein said graphics comprises a logo graphic.

13. The system for protecting a machine readable card of claim 10 wherein said printable material comprises thermal transfer printable material.

14. The system for protecting a machine readable card of claim 10 wherein said printable material comprises a matte top-coat to receive said graphics.

15. The system for protecting a machine readable card of claim 1 further comprising an adhesive on said second side of said cover; wherein said adhesive is capable of attaching said cover to said machine readable card.

16. The system for protecting a machine readable card of claim 15 wherein said adhesive comprises an acrylate polymer adhesive.

17. The system for protecting a machine readable card of claim 15 wherein said adhesive does not comprise an acid; thereby, said machine readable components are not damaged by said cover.

18. The system for protecting a machine readable card of claim 1 wherein said cover is capable of attaching to said machine readable card by static electricity.

19. The system for protecting a machine readable card of claim 1 wherein said cover thickness is less than 0.081 mm.

20. The system for protecting a machine readable card of claim 1 wherein one or more signals from said machine readable components are readable though said cover.

21. The system for protecting a machine readable card of claim 1 wherein said cover is repositionable on said machine readable card by pealing said cover from said machine readable card, repositioning said cover on said machine readable card, and reapplying said cover to said machine readable card.

22. The system for protecting a machine readable card of claim 1 wherein
said cover width is equal to said card width and
said cover height is equal to said card height.

23. A method for protecting a card comprising:
aligning a cover with a portion of a card, and
applying said cover to a second side of said card; wherein,
said cover comprises a first side, said second side, a cover height, a cover width, and a cover thickness;
said card comprises a card width, a card height, a first side, a second side, and a card thickness; and
said cover is capable of detaching from and reapplying to said card.

24. The method for protecting a card of claim 23 further comprising covering a magnetic strip on said card.

25. The method for protecting a card of claim 23 further comprising
applying a thumbprint to said card and
covering said thumbprint with said cover.

26. The method for protecting a card of claim 23 further comprising
signing said card in a signature block and
covering said signature block with said cover.

27. A system for protecting an identification card comprising:
a cover having a first side, a second side, a cover height, a cover width, and a cover thickness; and,
an identification card comprising one or more identification components, a card width and a card height; wherein,
said cover is capable of attaching and covering a portion of said identification card, and
said cover is capable of detaching from and reapplying to said identification card.

28. The system for protecting an identification card of claim 27 said cover comprises a polyester film capable of receiving one or more graphics by thermal transfer.

29. The system for protecting an identification card of claim 27 further comprising an adhesive on said second side of said cover; wherein
said adhesive is capable of attaching and covering said portion of said identification card, and
said adhesive comprises an acrylate polymer adhesive.

30. The system for protecting an identification card of claim 27 wherein one or more signals from said identification components are readable though said cover.
